(19) United States
(12) Patent Application Publication
(10) Pub. No.: US 2024/0351586 A1
(43) Pub. Date: Oct. 24, 2024

(54) DRIVER-ASSISTANCE SYSTEM FOR PERFORMING A LANE CHANGE HAVING A ROTATING LIDAR SENSOR ON A ROOF OF A VEHICLE

(71) Applicant: FEV Group GmbH, Aachen (DE)

(72) Inventors: Hamzeh Alzu'bi, Auburn Hills, MI (US); Elizabeth Taylor, Auburn Hills, MI (US); Sherif Matta, Auburn Hills, MI (US); Thomas Tasky, Auburn Hills, MI (US)

(73) Assignee: FEV Group GmbH, Aachen (DE)

(21) Appl. No.: 18/137,557

(22) Filed: Apr. 21, 2023

(51) Int. Cl. B60W 30/18; B60W 60/00; G01S 7/481; G01S 17/89; G01S 17/931

(52) U.S. Cl. CPC B60W 30/18163; B60W 60/0027; G01S 7/4817; G01S 17/89; G01S 17/931; B60W 2420/408; B60W 2554/4041

(57) ABSTRACT

The present disclosure relates to a driver-assistance system for assisting a driver of a vehicle in performing a lane change of the vehicle, the driver-assistance system including a sensor system for detecting a further vehicle located in an environment of the vehicle, wherein the driver-assistance system is configured to detect a position of the further vehicle dependent on sensor data generated by the sensor system and to check whether there is enough space for performing the lane change of the vehicle dependent on at least the position of the further vehicle and to generate a signal for initiating the lane change wherein when there is enough space for performing the lane change, wherein the sensor system includes a continuously spinning Lidar sensor mounted on a roof of the vehicle.

### TECHNICAL FIELD

The present disclosure relates in general to the field of automated or semi-automated driven vehicles and, in particular, to a driver-assistance system for assisting a driver of a vehicle in performing a lane change of the vehicle and a method for assisting a driver of a vehicle in performing a lane change of the vehicle.

### BACKGROUND

Autonomous driving systems may utilize sensor data generated by various sensors of the vehicle in order to enhance the efficiency and the driving comfort of autonomously or semi-autonomously driven vehicles. For example, autonomous and semi-autonomous driving systems and methods for autonomous and semi-autonomous driving may assist a driver of the vehicle in situations in which the driver or other traffic users may perform a lane change using the sensor data. Generally, the more accurately the sensor data captures an environment of the vehicle, the more desirable the lane change may be performed autonomously or semi-autonomously.

### SUMMARY

Various embodiments provide a driver-assistance system for assisting a driver of a vehicle in performing a lane change of the vehicle and a method for assisting a driver of a vehicle in performing a lane change of the vehicle as described by the subject matter of the independent claims. Advantageous embodiments are described in the dependent claims. Embodiments of the present disclosure can be freely combined with each other if they are not mutually exclusive.

In one aspect, the present disclosure relates to a driver-assistance system for assisting a driver of a vehicle in performing a lane change of the vehicle. The driver-assistance system includes a sensor system for detecting a further vehicle located in an environment of the vehicle. The driver-assistance system is configured to detect a position of the further vehicle dependent on sensor data generated by the sensor system. Furthermore, the driver-assistance system is configured to check whether there is enough space for performing the lane change of the vehicle dependent on at least the position of the further vehicle. Stated differently, the driver-assistance system is configured to check whether a gap for performing the lane change of the vehicle is big enough dependent on at least the position of the further vehicle.

Furthermore, the driver-assistance system is configured to generate a signal for initiating the lane change wherein when there is enough space for performing the lane change. The sensor system includes a continuously spinning Lidar sensor mounted on a roof of the vehicle.

In another aspect, the present disclosure relates to a method for assisting a driver of a vehicle in performing a lane change of the vehicle, the method including the following steps:
Generating sensor data by a sensor system for detecting a further vehicle located in an environment of the vehicle, wherein the sensor system includes a continuously spinning Lidar sensor mounted on a roof of the vehicle;
Detecting a position of the further vehicle dependent on the sensor data;
Checking whether there is enough space for performing the lane change of the vehicle dependent on at least the position of the further vehicle;
Generating a signal for initiating the lane change wherein when there is enough space for performing the lane change.

The driver-assistance system may include an electronic control unit (ECU) for processing the sensor data. The ECU may include one or more processors, and other components, for example one or more memory modules that stores logic that is executable by the one or more processors. Each of the one or more processors may be a controller, an integrated circuit, a microchip, central processing unit or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, etc., that may be compiled or assembled into computer-executable instructions and storage on the one or more memory modules. Alternatively, the computer-executable instructions may be written in our hardware description language, such as logic implemented via either a field programmable gate array (FPGA) configuration or an application specific integrated circuit (ASIC), all their equivalents. Accordingly, the methods and/or processes described herein may be implemented in any conventional computer programming language, as preprogrammed hardware elements, or as a combination of hardware and software components.

In one example, the ECU may be configured to determine the position of the further vehicle dependent on the sensor data. The ECU may calculate the position of the further vehicle as a position relative to the vehicle.

The sensor data may include Lidar signals that may be generated by the sensor system by the Lidar sensor. In most use cases, the Lidar sensor may emit laser pulses, wherein the laser pulses leave the Lidar sensor successively at temporal intervals. In one example, a wave length of the laser pulses may be in the infrared spectrum.

The Lidar signals may include information about a respective horizontal and a respective vertical angle at which the respective laser pulse leaves the Lidar sensor and a respective duration that is measured between an emission of the respective laser pulse and a reception of respective light pulses generated by a reflection of the respective laser pulse at an object in the environment of vehicle. The respective horizontal angle may describe a respective angle between a direction of propagation of the respective laser pulse and a fixed axis of the vehicle, for example the longitudinal axis of the vehicle, in a horizontal plane parallel to a surface of a road on which the vehicle is located. The respective vertical angle may indicate a respective angle between the direction of propagation of the respective laser pulse and an axis of rotation of the Lidar sensor in a vertical plane that is perpendicular to the horizontal plane. The respective duration may be associated with the respective horizontal and vertical angle.

The driver-assistance system, such as the ECU or a processor of the Lidar sensor, may determine a respective distance dependent on the respective duration, which is associated with the respective horizontal and vertical angle. The respective distance combined with the associated respective horizontal and vertical angle may represent a respective point where the respective laser pulse emitted by the Lidar sensor at the respective horizontal and vertical angle is reflected in a three dimensional space of the environment of the vehicle. A set of points that are determined in this manner may form a point cloud. The respective point may be described in Cartesian coordinates dependent on the respective vertical and horizontal angle and the respective distance associated with the respective point.

The Lidar sensor may emit the laser pulses at regular time intervals as the Lidar sensor rotates around the axis of rotation in order to generate the point cloud. The axis of rotation may be perpendicular to the surface of the roof of the vehicle. Wherein when the vehicle drives straight, the axis of rotation may be perpendicular to the surface of the road.

In the context of this disclosure, the phrase “continuously spinning Lidar sensor” means that at least one part of the Lidar sensor is rotating continuously in time. For example, the rotating part of the Lidar sensor may be a mirror or a housing of the Lidar sensor. In the last case, the Lidar sensor may have a wireless connection to the ECU in order to transmit the sensor data to the ECU. In another example, the rotating part may be in the form of a rotating unit including lenses and one or more printed circuit boards with laser diodes and photodiodes.

The Lidar sensor may include a driving element. The driving element may generate a constant torque in order to provide a continuous rotation of the Lidar sensor, such as a continuous rotation of the rotating part of the Lidar sensor. The driving element may be an electric motor. The continuous rotation of the Lidar sensor may have the advantage that an accuracy of the point cloud is higher compared to a system that does not include a continuously rotating Lidar sensor.

The advantage of the Lidar sensor over a radar sensor is that the Lidar sensor may produce the laser pulses that have a shorter wavelength than the wavelength of electromagnetic waves generated by the radar sensor and therefore may provide a higher accuracy. The ECU may be configured to determine geometric dimensions of the further vehicle based on the sensor data, and may be dependent on the point cloud. The ECU of the driver-assistance system may include one or more filters to extract features from the point cloud. The features may include lines, line orientations, line locations, corner characteristics and colors. The filters may be in the form of neural networks or other trained models. The filters may be generated by machine learning algorithms. Furthermore, the filters may be programmed off-line and maybe developed experimentally, empirically, predictably, through modeling or other techniques for accurately train distinguishing the features.

The ECU of the driver-assistance system may include an object recognition module for recognizing the further vehicle as a vehicle. The object recognition module may be configured to recognize the further vehicle as a vehicle based on recognized features, which may be detected by the filters.

The term “module” as used herein refers to any known or in the future developed hardware, software such as an executable program, artificial intelligence, fuzzy-logic or combination hereof for performing a function associated with the “module” or being a result of having performed the function associated with the “module”.

As used herein, the singular forms “a”, “an” and “the” include plural references unless the context clearly dictates otherwise. Thus, for example, reference to a component includes aspects having two or more such components, unless the context clearly indicates otherwise. For example, the ECU of the driver-assistance system is configured to detect the position of the further vehicle dependent on the sensor data, the driver-assistance system, such as the ECU, may be configured to detect positions of further vehicles, including the further vehicle, located in the environment of the vehicle dependent on the sensor data. The environment of the vehicle includes a front region located in front of the vehicle, a left side region located to the left of the vehicle, a right side section located to the right of the vehicle and a rear region located behind the vehicle. The driver-assistance system may be able to detect positions of all vehicles located in the environment of the vehicle by the spinning Lidar sensor. In one example, the front region may extend approximately to a distance of 10 to 200 meters from the vehicle. Similarly, the rear region may extend approximately to a distance from 10 to 100 meters from the vehicle. The side regions may extend approximately to a distance of 1 to 5 meters from the vehicle.

As the sensor system includes the continuously spinning Lidar sensor, the proposed driver-assistance system may capture not only a vehicle being located either in the front of the vehicle or behind the vehicle but all the vehicles situated in the environment of the vehicle including the front region, the left side region, the right side region and the rear region. In addition, the proposed driver-assistance system may enable to detect all the vehicles in the environment of the vehicle using a single sensor, namely the continuously spinning Lidar sensor. This may reduce the amount of material compared to using several Lidar sensors located at the front, the left side, the right side and the rear of the vehicle.

Furthermore, as the spinning Lidar sensor is mounted on the roof of the vehicle, the proposed driver-assistance system may be able to detect one or more occluded vehicles in the environment of the vehicle. The one or more occluded vehicles may be occluded by an object located directly behind or directly in front of the vehicle or being located within one of the side regions of the vehicle. Thus, the environment of the vehicle may be captured more accurately using the proposed driver-assistance system including the continuously spinning Lidar sensor mounted on the roof of the vehicle.

The driver-assistance system, such as the ECU, may be configured to determine a velocity, and a direction of the velocity, of the further vehicle dependent on the sensor data, dependent on the Lidar signals. Similarly, the driver-assistance system, such as the ECU, may be configured to determine a respective velocity and a respective direction of the respective velocity, of the respective vehicle of the further vehicles in the environment of the vehicle dependent on the sensor data, such as dependent on the Lidar signals.

By detecting all the vehicles in the environment of the vehicle based on the sensor data, such as based on the Lidar signals, the driver-assistance system, such as the ECU, may check whether there is enough space for performing the lane change of the vehicle.

The driver-assistance system, such as the ECU, may check whether there is enough space for performing the lane change of the vehicle dependent on the position, the velocity and the direction of the velocity of the further vehicle.

In some instances, the driver-assistance system, such as the ECU, may check whether there is enough space for performing the lane change of the vehicle dependent on the position, the velocity and the direction of the velocity of each vehicle of the further vehicles in the environment of the vehicle.

According to one embodiment, the driver-assistance system may be configured to determine the velocity of the further vehicle dependent on the sensor data and to predict a driving path of the further vehicle dependent on the position and the velocity of the further vehicle and to check whether there is enough space for the lane change dependent on the predicted driving path of the further vehicle. Using the predicted path of the further vehicle may enhance the confidence that the gap for performing the lane change is big enough.

According to a further embodiment, the signal for initiating the lane change may be in the form of an enabled driver-vehicle-interface for initiating the lane change. In one example, the driver-vehicle-interface may be in the form of a touchscreen. The driver-vehicle-interface may be a part of the touchscreen. In this case, the enabled driver-vehicle-interface may be an activated button on the touchscreen. The activated button may allow the driver to initiate the lane change by touching the activated button. Stated differently, the signal for initiating the lane change may be displayed as a visual information. The displayed signal for initiating the lane change may allow the driver to start the lane change. The performing of the lane change may be initiated by touching the activated button or by pressing a further button of a dashboard of the vehicle. In one example, a driver-vehicle-interface may be enabled for initiating the lane change via the driver-vehicle-interface in response to generating the signal for initiating the lane change.

In another embodiment, the driver-assistance system may be configured to initiate the lane change autonomously in response to a generation of the signal for initiating the lane change. This embodiment may have the advantage that the lane change may be performed autonomously after the signal for initiating the lane change has been generated. According to this embodiment, the signal for initiating the lane change may be in the form of an output signal of an evaluation module of the ECU. The evaluation module may be configured to check whether there is enough space for performing the lane change based on the sensor data as described above. The output signal of the evaluation unit of the ECU may be processed by a control module of the ECU in order to trigger the performing the lane change.

The ECU, in particular the control module, may be configured to control components of the vehicle for performing the lane change. The components of the vehicle may include a steering system, a control unit of the steering system, a drive unit, a control unit of the drive unit and a brake system, and a control unit of the brake system.

According to one embodiment, the driver-assistance system may include an inertial measurement unit (IMU) and the driver-assistance system may be configured to detect an angle of the vehicle to the surface of the road on which the vehicle is located dependent on further sensor data generated by the IMU. According to this embodiment, the driver-assistance system may be configured to determine the position of the further vehicle dependent on the angle of the vehicle to the surface of the road. As an underbody of the vehicle may not be parallel to the surface of the road, the data of the point cloud needs to be corrected taking into account the angle of the vehicle to the surface. The angle of the vehicle to the surface of the road may be ninety degrees if the vehicle is stationary and unloaded. The driver-assistance system may be configured to correct the sensor data dependent on the further sensor data, dependent on the angle of the vehicle to the surface of the road. The advantage of using the IMU may be that it may be checked more reliable if there is enough space for performing the lane change as the sensor data may be corrected using the IMU.

According to a further embodiment, the sensor data may be in the form of the point cloud, as described above. According to this further embodiment, the driver-assistance system, such as the ECU, may be configured to remove points of the point cloud that represent points located on the surface of the road on which the vehicle is located from the point cloud. This has the advantage, that the amount of the sensor data may be reduced. This may speed up detecting the further vehicle as a vehicle. For example, the object recognition module may need to process less sensor data for recognizing the further vehicle if the points representing the points located on the surface of the road are removed from the point cloud.

According to a further embodiment, the driver-assistance system may be configured to generate coordinates of each point of the point cloud on the basis of a coordinate system of the vehicle, wherein one axis of the coordinate system of the vehicle forms a first plane with a rear axle of the vehicle that is perpendicular to the surface of the road. The coordinates of each point of the point cloud measured on the basis of the coordinate system of the vehicle may be referred to as vehicle coordinates of each point in the following.

The vehicle coordinates of the respective point of the point cloud may be determined by calculating Cartesian coordinates on the basis of the respective horizontal angle, the respective vertical angle and the respective distance associated with the respective point and shifting the Cartesian coordinates along the longitudinal axis of the vehicle such that the vehicle coordinates originate within the first plane. This has the advantage that the one axis of the coordinate system of the vehicle, which forms the first plane with the rear axle, extends to the instant center of rotation of the vehicle. This may be advantageous for calculating future positions of the further vehicle with respect to the vehicle. In the latter case, a future movement of the vehicle may be taken into account. Using the vehicle coordinates may reduce computational effort for checking whether the gap for performing the lane change is big enough if the one axis of the coordinate system of the vehicle, which forms the first plane with the rear axle, extends to the instant center of rotation of the vehicle.

### BRIEF DESCRIPTION OF THE DRAWINGS

In the following, embodiments of the present disclosure are explained in greater detail, by way of example only, making reference to the drawings in which:

FIG. 1 schematically illustrates a vehicle with a driver-assistance system for assisting a driver of a vehicle in performing a lane change of the vehicle including a sensor system with a rotating Lidar sensor;

FIG. 2 illustrates a control unit of the driver-assistance system shown in FIG. 1 and the Lidar sensor shown in FIG. 1 with a rotating part;

FIG. 3 is schematically illustrating a variant of the rotating part shown in FIG. 2;

FIG. 4 is schematic for explaining the function of the sensor system as shown in FIG. 1 and FIG. 2 in a traffic situation shown from a top view;

FIG. 5 depicts a part of the traffic situation shown in FIG. 4 from a side view;

FIG. 6 schematically illustrates the control unit of the driver-assistance system shown in FIG. 2;

FIG. 7 shows a driver-vehicle-interface for initiating a performing of a lane change of the vehicle;

FIG. 8 is a top view of the vehicle shown in FIG. 1 to illustrate the instant center of rotation of the vehicle;

FIG. 9 shows a schematic front view of the vehicle shown in FIG. 1 to illustrate an inclination of the vehicle with respect to a surface of a road; and

FIG. 10 depicts steps of a method for assisting a driver of a vehicle in performing a lane change of the vehicle.

### DETAILED DESCRIPTION

The descriptions of the various embodiments of the present disclosure will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

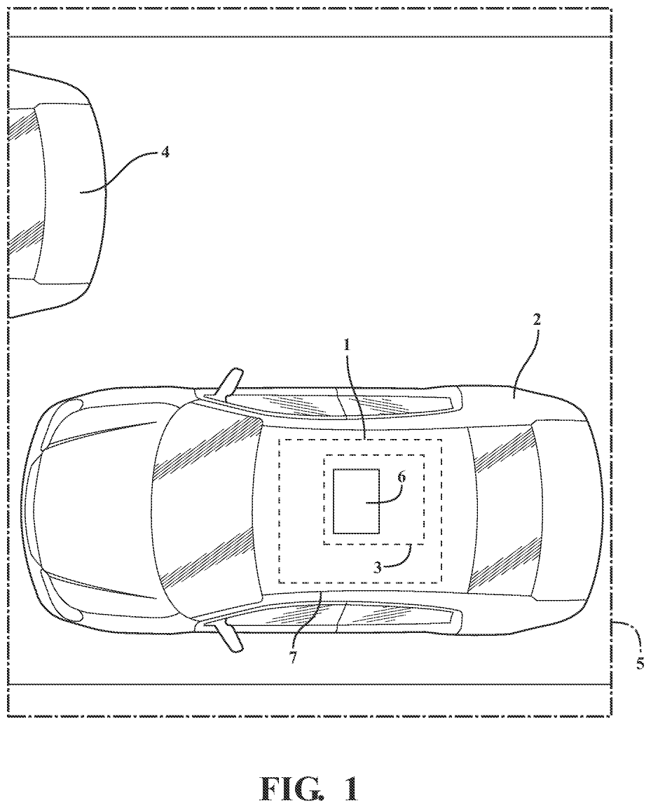

FIG. 1 illustrates an exemplary driver-assistance system 1 of the above-mentioned driver-assistance system for assisting a driver of an exemplary vehicle 2 of the above-mentioned vehicle in performing a lane change of the vehicle 2. The driver-assistance system 1 includes an exemplary sensor system 3 of the above-mentioned sensor system for detecting an exemplary further vehicle 4 of the above-mentioned further vehicle located in an environment 5 of the vehicle 2. The vehicle and the further vehicle 4 may be located on a road 8. The driver-assistance system 1 is configured to detect a position of the further vehicle 4 dependent on sensor data generated by the sensor system 3. Furthermore, the driver-assistance system 1 is configured to check whether there is enough space for performing the lane change of the vehicle 2 dependent on at least the position of the further vehicle 4. In addition, the driver-assistance system 1 is configured to generate a signal for initiating the lane change wherein when there is enough space for performing the lane change. The sensor system 3 includes a continuously spinning Lidar sensor 6, which is mounted on a roof 7 of the vehicle 2.

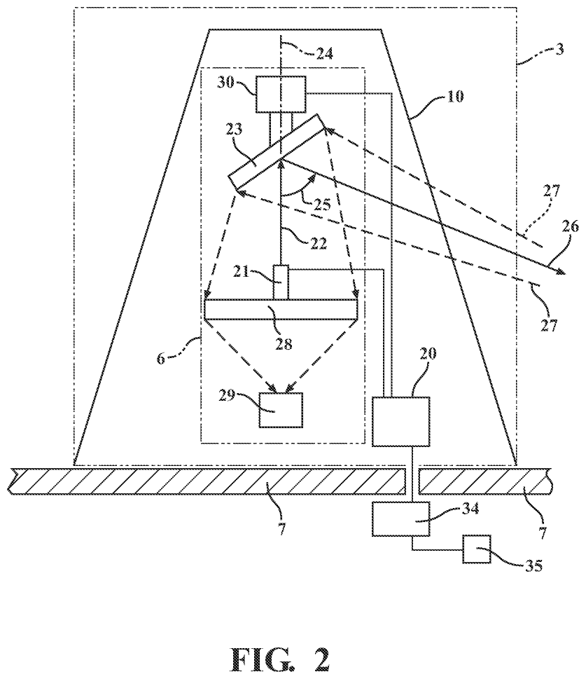

FIG. 2 illustrates schematically the sensor system 3 with the Lidar sensor 6. The sensor system 3 may include a housing 10 covering the Lidar sensor 6 and a first control unit 20 for controlling a laser 21 and a drive unit 30. The drive unit 30 may be an electric motor. The housing may be firmly connected to the roof 7. The continuously spinning Lidar sensor 6 includes at least one continuously spinning part 23. The spinning part 23 is driven by the drive unit 30 and rotates around an axis of rotation 24 continuously in time. The spinning, i.e. rotating, part 23 may be in the form of a mirror according to one example. The drive unit 30 may generate a constant torque on the spinning part 23 in order to produce a constant angular velocity of the spinning part 23. This may enhance the accuracy of the sensor system 3. The first control unit 20 may control the drive unit 30 such that the angular velocity of the rotating part 23 may be constant.

The laser 21 generates laser pulses 22, which are reflected at a surface of the rotating part 23 while the rotating part 23 rotates about the axis of rotation 24. According to FIG. 2, an angle of reflection 25 of the laser pulses 22 is measured as an angle between the axis of rotation 24 and an outgoing direction 26 of the laser pulses 22 leaving the sensor system 3. The laser pulses 22 propagate in the direction 26 within the drawing plane of FIG. 2 and are reflected at points of objects located in the environment 5 of the vehicle 2. A reflection of the respective laser pulse of the laser pulses 22 produces a respective set of reflected light pulses spreading in various directions within the environment 5. A part of the respective set of reflected light pulses spreads in the direction of the rotating part 23.

In FIG. 2, several sets of the reflected light pulses are shown schematically and are marked together with the reference number 27. The surface of the rotating part 23 may direct the sets 27 to a receiving lens 28 of the Lidar sensor 6. The receiving lens 28 bundles the light pulses of each set of the sets 27 such that the light pulses of each set hit a detector 29 of the Lidar sensor 6. The detector 29 may include a set of photodiodes in one example. The housing 10 may provide supports for mounting the laser 29, the drive unit 30, the receiving lens 28 and the detector 29 firmly with respect to the roof 7. The supports are not shown in FIG. 2 for the sake of clarity.

Each time when the respective set of light pulses of the sets 27 of the reflected light pulses hits the detector 29, such that the detector 29, and/or components thereof such as the photodiodes, may generate respective electrical signals. The first control unit 20 may receive the electrical signals and may generate the Lidar signals described above dependent on the electrical signals. In one example, the first control unit 20 may initiate an emission of a respective laser pulse of the laser pulses 22 by sending a control signal to the laser 21. Furthermore, the first control unit 20 may measure a length of a respective time interval between the emission of the respective laser pulse and a respective receiving of the respective electrical signals produced by the detector 29. In addition, the control unit 20 may track a current angle of the rotating part 23.

The first control unit 20 may generate first data sets. A respective data set of the first data sets may include a respective angle of the rotating part 23 and the measured length of the respective time interval between the emission of the respective laser pulse and the generation and receiving of the respective electrical signals when the respective set of light pulses of the sets 27 generated by a reflection of the respective laser pulse hits the detector 29. The first data sets may be considered as a part of the sensor data mentioned above.

The respective angle may be the current angle of the rotating part 23 at the moment of the emission of the respective pulse of the laser pulses 22. The respective angle may be equal to a respective angle between a direction of propagation of the respective laser pulse and a longitudinal axis 41 of the vehicle 2 within a horizontal plane as shown in FIG. 4.

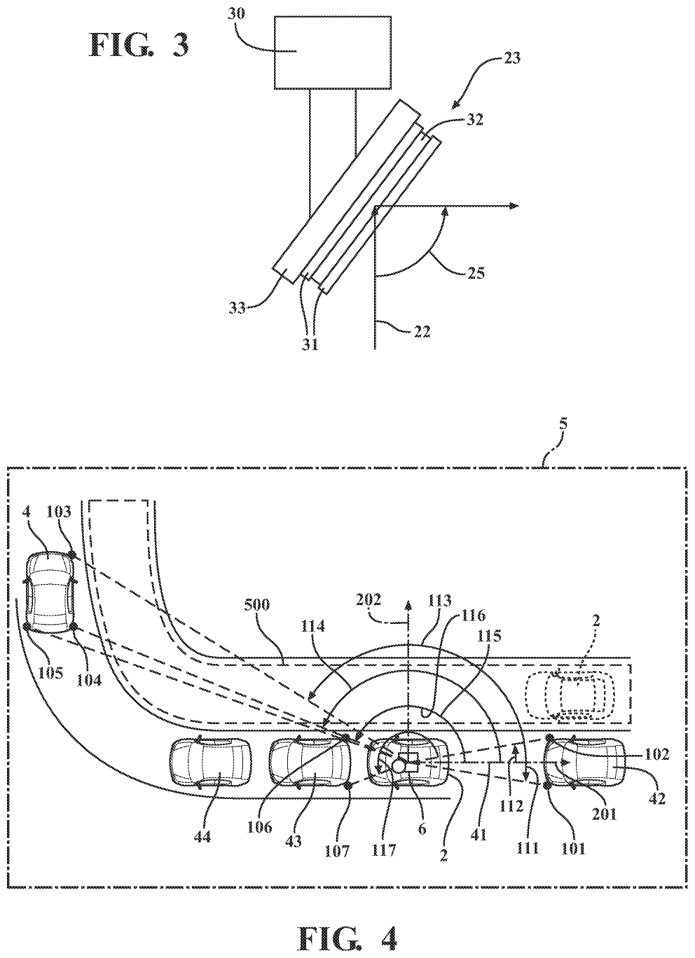

The first control unit 20 may be configured to vary the angle of reflection 25 of the laser pulses 22. According to one example, the Lidar sensor 6 may include a further drive unit, not shown in FIG. 2, for turning the rotating part 23 in the drawing plane of FIG. 2 in order to change the angle of reflection 25 of the laser pulses 22. In this case, the first control unit 20 may be configured to control the further drive unit to provoke a change of the angle of reflection 25. According to a further example depicted in FIG. 3, the rotating part 23 may include a liquid crystal layer 32. In some embodiments, the rotating part 23 may be covered by two thin layers 31. The first control unit 20 may be configured to apply a voltage to the liquid crystal layer 32, via the thin layers 31, in order to change the refractive index of the liquid crystal layer 32. By changing the refractive index of the liquid crystal layer 32 a time delay of the laser pulses 22 may be changed when the laser pulses 22 propagate through the crystal layer 32. This may cause a change of the angle of reflection 25. According to one example, the rotating part 23 may be constructed such that the laser pulses 22 reflects off the layer of the two layers 31 that is directly mounted to a support 33 of the rotating part 23. The support 33 may be connected to a shaft of the drive unit 30.

In one example, the first control unit 20 may be configured to keep the angle of reflection 25 constant during a full rotation of the Lidar sensor 6 around the axis of rotation 24. The first control unit 20 may vary the angle of reflection 25 at regular further time intervals, wherein during each further time interval the Lidar sensor 6 completes at least one full rotation about the axis of rotation 24 and the angle of reflection 25 is constant. In one example, the angle of reflection 25 may be changed in 0.1 degree steps. In one example, the angle of reflection 25 may be adjusted in steps starting from 60 degrees up to 90 degrees. Of course, this kind of variation of the angle of reflection 25 may represent just one example of how the angle of reflection 25 may be varied while the Lidar sensor 6 rotates about the axis of rotation 24 in order to scan the environment 5 systematically.

The environment 5 may be scanned by the Lidar sensor 6 by changing the angle of reflection 25 at the further time intervals and spinning the rotating part 23 during a first measurement period, for example during a few seconds. The Lidar sensor 6 spins continuously in time during the first measurement period. The Lidar sensor 6 may complete several revolutions, for example between 10 and 20 revolutions per second, during the first measurement period in order to scan the environment 5 systematically.

According to one example, the respective data set may include the respective angle and the length of the respective time interval, as mentioned above, and, in addition, a respective value of the angle of reflection 25 at the moment the respective laser pulse of the laser pulses 22 is emitted.

Alternatively or in addition, the respective data set may include a respective distance calculated on the basis of the length of the respective time interval. The respective distance may be equal to half of the product of the respective duration and the speed of light. The first control unit 20 may send the first data sets to a second control unit 34 of the vehicle 2. FIG. 2 shows a wired connection between the first control unit 20 and the second control unit 34. The wired connection may be in the form of an Ethernet connection. Alternatively, there may be provided a wireless connection between the first control unit 20 and the second control unit 34. Wherein when, the first data sets may not include the respective distance, the second control unit 34 may calculate the respective distance dependent on the respective duration of each data set.

FIG. 4 depicts a first use case of the proposed driver-assistance system 1, wherein in addition to the further vehicle 4, a second further vehicle 42 is located in front of the vehicle 2, a third further vehicle 43 is located behind the vehicle 2 and a fourth further vehicle 44 is located behind the third further vehicle 43.

By pivoting the part 23 about the axis of rotation 24 and adjusting the angle of reflection 25 over the first measurement period, as described above, the environment 5 may be scanned such that the laser pulses 22 reflect at several points of one or more surfaces of each vehicle, including the further vehicles 4, 42, 43 and 44, located within the environment 5. For sake of clarity, FIG. 4 shows only a couple of points at which the laser pulses 22 are reflected on one or more surfaces of the respective vehicle of the further vehicles 4, 42, 43 and 44.

For example, FIG. 4 illustrates a first point 101 and a second point 102, where a first and a second laser pulse of the laser pulses 22 respectively are reflected off a surface of the second further vehicle 42, and a third point 103, a fourth point 104 and a fifth point 105, where a third, a fourth and a fifth laser pulse of the laser pulses 22 respectively are reflected off a surface of the further vehicle 4, and a sixth point 106 and a seventh point 107, where a sixth and a seventh laser pulse of the laser pulses 22 respectively are reflected off a surface of the third further vehicle 43.

The Lidar sensor 6 may emit the first laser pulse at a first angle 111 to the longitudinal axis 41 of the vehicle 2 during a first time interval during which the first laser pulse hits the first point 101. In this case, a reflection of the first laser pulse at first the point 101 may generate a first set of reflected light pulses. The first time interval may start when the laser 21 emits the first laser pulse and may end when the first control unit 20 receives first electrical signals generated by the detector 29. The detector 29 may generate the first electrical signals in response to the first set of the reflected light pulses hitting the detector 29.

Similarly, the Lidar sensor 6 may emit the second laser pulse at a second angle 112 to the longitudinal axis 41 of the vehicle 2 during a second time interval during which the second laser pulse hits the second point 102. In this case, a reflection of the second laser pulse at second the point 102 may generate a second set of reflected light pulses.

Analogously, the Lidar sensor 6 may emit the third laser pulse at a third angle 113 to the longitudinal axis 41 of the vehicle 2 during a third time interval during which the third laser pulse hits the third point 103. A reflection of the third laser pulse at third the point 103 may generate a third set of reflected light pulses.

Analogously, the Lidar sensor 6 may emit the fourth laser pulse at a fourth angle 114 and the fifth laser pulse at a fifth angle 115 to the longitudinal axis 41 of the vehicle 2 during a fourth and fifth time interval respectively during which the fourth laser pulse hits the fourth point 104 and the fifth laser pulse hits the fifth point 105 respectively. A reflection of the fourth laser pulse at fourth the point 104 may generate a fourth set of reflected light pulses. A reflection of the fifth laser pulse at fifth the point 105 may generate a fifth set of reflected light pulses.

In an analogous way, the Lidar sensor 6 may emit the sixth laser pulse at a sixth angle 116 and the seventh laser pulse at a seventh angle 117 to the longitudinal axis 41 of the vehicle 2 during a sixth and seventh time interval respectively during which the sixth laser pulse hits the sixth point 106 and the seventh laser pulse hits the seventh point 107 respectively. A reflection of the sixth laser pulse at sixth the point 106 may generate a sixth set of reflected light pulses. A reflection of the seventh laser pulse at seventh the point 107 may generate a seventh set of reflected light pulses.

The second, third, fourth, fifth, sixth and seventh time interval may respectively start when the laser emits the second, third, fourth, fifth, sixth and seventh laser pulse respectively and may respectively end when the second, third, fourth, fifth, sixth and seventh set of reflected light pulses hits the detector 29 respectively. The first, second, third, fourth, fifth, sixth and seventh time interval may be that short such that a position of the Lidar sensor 6 relative to the longitudinal axis 41 may be considered as constant during the first, second, third, fourth, fifth, sixth and seventh time interval respectively.

The first control unit 20 may be configured to generate a first data set including a value of the first angle 111, a length of the first time interval and a value of the angle of reflection 25 at which the first laser pulse is reflected at the rotating part 23 before leaving the Lidar sensor 6. Analogously, the first control unit 20 may generate a second, third, fourth, fifth, sixth and seventh data set including a value of the second, third, fourth, fifth, sixth and seventh angle 112, 113, 114, 115, 116, 117 respectively, a length of the second, third, fourth, fifth, sixth and seventh time interval respectively and a respective value of the angle of reflection 25 at which the second, third, fourth, fifth, sixth and seventh laser pulse respectively is reflected at the rotating part 23 before leaving the Lidar sensor 6.

The above mentioned first data sets may include the first, second, third, fourth, fifth, sixth and seventh data set. Thus, the description of generating the first, second, third, fourth, fifth, sixth and seventh data set may exemplarily describe how the points of the above mentioned point cloud may be obtained during the first measurement period. Thus, the point cloud may include the first, second, third, fourth, fifth, sixth and seventh point 101, 102, 103, 104, 105, 106 and 107. The second control unit 34 may store the first data sets obtained during the first measurement period in the form of a first database 300. The point cloud obtained as a result of a scanning of the environment 5 during the first measurement period may be referred to as the first point cloud in the following.

Similarly, as the first data sets representing the first point cloud are generated, second data sets representing a second point cloud may be generated. For this purpose, the environment 5 may be rescanned by the Lidar sensor 6 by changing the angle of reflection 25 and spinning the rotating part 23 during a second measurement period, for example during another few seconds. The Lidar sensor 6 spins continuously in time during the second measurement period. The second measurement period may follow immediately after the first measurement period. Obviously, the further vehicles 4, 42, 43, 44 may change their relative positions to the vehicle 4 from the first measurement period to the second measurement period. The second control unit 34 may store the second data sets obtained during the second measurement period in the form of a second database 400. The second data sets may be considered as a part of the sensor data mentioned above.

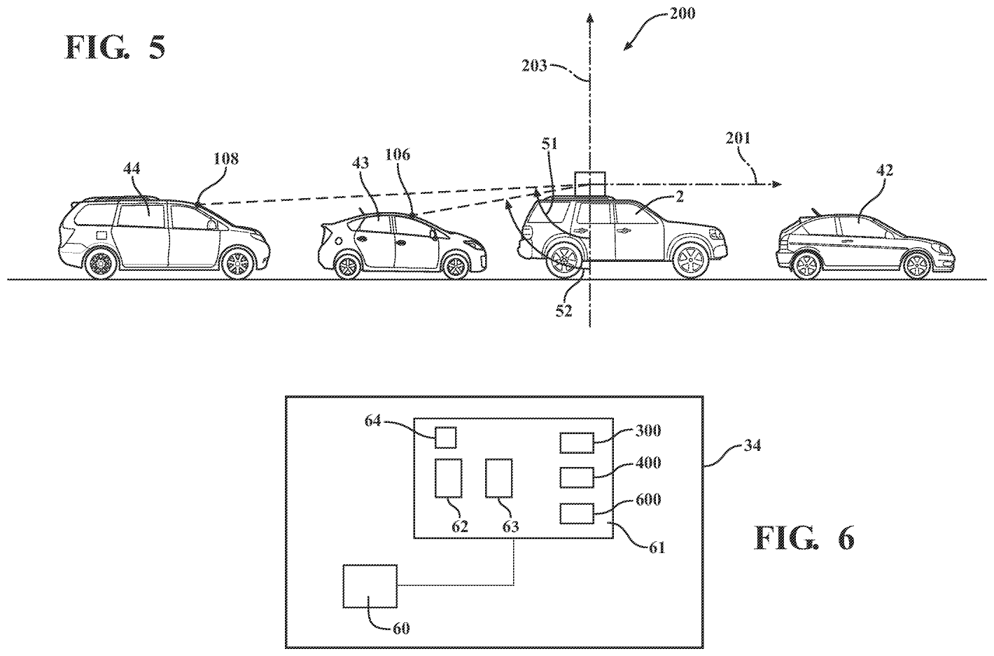

FIG. 5 shows how the fourth further vehicle 44 may be detected by the Lidar sensor 6 because the Lidar sensor 6 is mounted on the roof 7 of the vehicle 2. FIG. 5 shows exemplary an eighth point 108 at which an eighth laser pulse of the laser pulses 22 reflects on a surface of the fourth vehicle 44. It can be seen that a first value of the angle of reflection 25, indicating a first angle 51 at which the eighth laser pulse reflects off the rotating part 23, is different to a second value of the angle of reflection 25, indicating a second angle 52 at which the eighth laser pulse reflects off the rotating part 23.

In FIG. 5, a coordinate system 200 of the Lidar sensor 6 is shown including an x-axis 201 and a z-axis 203. A y-axis 202 of the coordinate system 200 is shown in FIG. 4. The first control unit 20 or the second control unit 34 may be configured to calculate respective coordinates of the respective point of the first point cloud, and also of the second point cloud, within the coordinate system 200 dependent on the respective data set of the first data sets representing the respective point.

The coordinates of the respective point of the first point cloud, and also of the second point cloud, may include a respective x-coordinate measured on the basis of the x-axis 201, a respective y-coordinate measured on the basis of the y-axis 202 and the respective z-coordinate measured on the basis of the z-axis 203. The x-coordinate of the respective point may be calculated dependent on a product of the respective distance, a cosine of the respective angle of the respective data set that represents the respective point and a sine of the respective value of the angle of reflection 25 of the respective data set that represents the respective point. Similarly, the y-coordinate of the respective point may be calculated dependent on a product of the respective distance, a respective sine of the respective angle of the respective data set that represents the respective point and the sine of the respective value of the angle of reflection 25 of the respective data set that represents the respective point.

The z-coordinate of the respective point may be calculated as a function of a distance of the respective data set and a cosine of the respective value of the angle of reflection 25 of the respective data set that represents the respective point.

FIG. 5 shows an example, wherein the coordinate system 200 originates inside the Lidar sensor 6 for sake of clarity. However, in other use cases the coordinate system 200 may originate inside the vehicle 2 or on a surface of the road 8.

FIG. 6 depicts schematically the second control unit 34. The second control unit 34 may include a processor 60 and a volatile memory 61, for example a RAM. The volatile memory 61 may store an objection recognition module 62 and the first database 300. The processor 60 may be configured to load and execute a main program 63. By executing the main program 63, the processor 60 may determine geometric dimensions of the further vehicles located in the environment 5, such as the further vehicle 4, the second further vehicle 42, the third further vehicle 43 and/or the fourth further vehicle 44, dependent on the first data base 300, dependent on the coordinates of the points of the first point cloud.

In one example, the volatile memory 61 may not store the first data base 300, but the coordinates of the points of the first point cloud calculated on the bases of the first data base 300. In this case. The first data base 300 may be stored in a memory of the first control unit 20, which is not shown for sake of clarity. In one example, the processor 60 may execute the object recognition module 62 for recognizing the further vehicles 4, 42, 43 and 44 as vehicles. The object recognition module 62 may include filters for recognizing the further vehicles as vehicles dependent on features. The features may be generated by the filters dependent on the first database 300. The features may involve lines, line orientations, edges, edge orientations, corner and corner orientations and the like, of surfaces of the further vehicles 4, 42, 43 and 44.

In one example, the features may be recognized by using a neural net of the object recognition module 62. In one example, the second control unit 34 may recognize the further vehicles 4, 42, 43 and 44 each as a vehicle by using a convolutional neural network (CNN) of the object recognition module 62. In this case, a first set of layers of neurons of the CNN may be trained to detect the features dependent on the first database 300, which may be used as an input of the CNN. A second set of layers of neurons of the CNN may be trained to recognize the further vehicles 4, 42, 43 and 44 as vehicles dependent on the features detected by the first set of layers of neurons of the CNN.

In response to recognizing the further vehicles 4, 42, 43 and 44 as vehicles, the second control unit 34 may determine a respective first position of the respective further vehicle 4, 42, 43 and/or 44 dependent on the first point cloud. The second control unit 34 may be configured to calculate the respective first position of the respective further vehicle 4, 42, 43 and/or 44 in the form of a respective relative position to the vehicle 2.

According to one example, the second control unit 34 may be configured to assign each point of the first point cloud to one of the further vehicles 4, 42, 43 or 44 respectively. In doing so, a respective shape of each of the further vehicles 4, 42, 43 and 44 may be obtained. The second control unit 34 may use a vehicle shape database 600 including various different vehicle shapes for assigning the points of the first point cloud to one of the further vehicles 4, 42, 43 or 44.

In one example, the second control unit 34 may create a respective set of bounding lines for representing the respective further vehicle of the further vehicles 4, 42, 43, 44. Based on the respective set of bounding lines the second control unit 34 may calculate the respective first position of the respective further vehicle 4, 42, 43 and/or 44, for example in the form of a respective center of gravity of the respective further vehicle 4, 42, 43, 44.

According to one example, the second control unit 34 may be configured to determine a zone 500 within which there is no object detected on the road 8. The zone 500 may be specified by bounding lines in a horizontal plane parallel to the surface of the road 8. In order to determine the bounding lines, the second control unit 34 may be programmed to remove points of the first point cloud that represent points located on the surface of the road 8 from the first point cloud. In most cases, the first point cloud contains such points because a part of the laser pulses 22 may reflect on the surface of the road 8. The first point cloud without these removed points may be referred to as reduced first point cloud in the following.

In one example, the second control unit 34 may determine the zone 500 as a zone that is limited by those points of the first point cloud or the reduced first point cloud that are assigned to one of the further vehicles 4, 42, 43 or 44. These points are also referred to as limiting points in the following. In other words, the limiting points may define the bounding lines of the zone 500 at least partially. In order to define the limiting points, the second control unit 34 may only chose those points of the first point cloud or the reduced first point cloud that have a prescribed distance, for example a distance in a range of 10 to 20 cm, to the surface of the road 8. This may speed up the determination of the bounding lines of the zone 500.

Furthermore, in one example, the second control unit 34 may check whether there are points of the first point cloud or the reduced first point cloud that are assigned to one of the further vehicles 4, 42, 43 or 44 and that are located to the left of the vehicle 2 if the vehicle 2 is supposed to perform the lane change to the lane to the left of the vehicle 2. In this case, the bounding lines of the zone 500 may be located in an area left to the vehicle 2. Such a use case is depicted in FIG. 4. Analogously, the second control unit 34 may check whether there are points of the first point cloud or the reduced first point cloud that are assigned to one of the further vehicles 4, 42, 43 or 44 and that are located to the right of the vehicle 2 if the vehicle 2 is supposed to perform the lane change to the lane to the left of the vehicle 2.

The second control unit 34 may be configured to determine whether the gap for performing the lane change is big enough dependent on a size of the zone 500 dependent on the bounding lines of the zone 500. In one example, the second control unit 34 may check by an evaluation module 64, whether the zone 500 extends in an area behind the vehicle 2 by more than a first prescribed length and whether a width of the zone 500 in the area behind the vehicle 2 exceeds a prescribed width. Analogously, the second control unit 34 may check by the evaluation module 64, whether the zone 500 extends in an area in front of the vehicle 2 by more than a second prescribed length and whether the width of the zone 500 in the area in front of the vehicle 2 exceeds the prescribed width. If both apply, the gap for performing the lane change is considered as big enough and the second control unit 34 may generate the signal for initiating the lane change.

The evaluation module 64 may be programmed to adapt the first and second prescribed length as a function of a velocity of the vehicle 2. The greater the velocity of the vehicle 2, the greater may be first and second prescribed length.

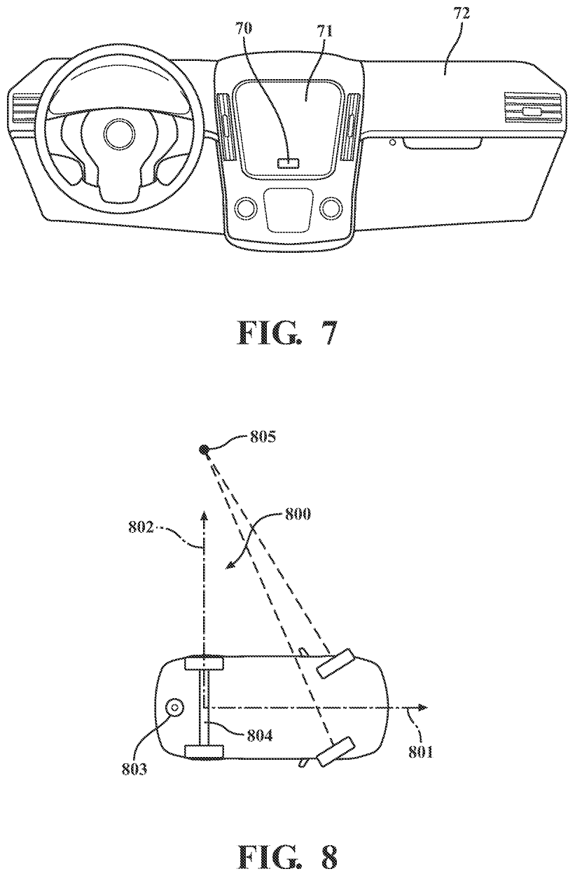

In one example, the second control unit 34 may generate the signal for initiating the lane change by enabling a driver-vehicle-interface for initiating the lane change. The driver-vehicle-interface may be in the form of an enabled button 70 of a touch screen 71 of a dashboard 72 of the vehicle 2, as shown in FIG. 7. The enabled button 70 may allow the driver of the vehicle 2 to initiate the performing of the lane change by touching the button 70. The second control unit 34 may be configured to send a trigger signal to a third control unit 35 of the vehicle 2 wherein when the button 70 is touched. The third control unit 35 may control components of the vehicle for performing the lane change in response to receiving the trigger signal from the second control unit 34. The components of the vehicle may include a steering system, and a control unit of the steering system, a drive unit, a control unit of the drive unit and a brake system, a control unit of the brake system. These components are not shown in the Figures for sake of clarity.

In one example, the driver-assistance system 1 may be configured to initiate the lane change autonomously in response to the generation of the signal for initiating the lane change. In this case, the second control unit 34 may generate the signal for initiating the lane change by sending the trigger signal to the third control unit 35 of the vehicle 2.

After the second measurement period, the second control unit 34 may recognize the further vehicles 4, 42, 43 and 44 as vehicles dependent on the second database 400. In addition, the second control unit 34 may determine a respective second position of the respective further vehicle 4, 42, 43 and/or 44 dependent on the second point cloud. The second control unit 34 may calculate the respective second position of the respective further vehicle 4, 42, 43 and/or 44 on the basis of the second database 400 in the same manner as the second control unit 34 determines the respective first position of the respective further vehicle 4, 42, 43 and/or 44 dependent on the first database 300.

The second control unit 34 may be programmed to compute a respective velocity of the respective further vehicle 4, 42, 43 and/or 44 dependent on the respective first and second position of the respective further vehicle 4, 42, 43 and/or 44. The second control unit 34 may calculate the respective velocity of the respective further vehicle 4, 42, 43 and/or 44 as a respective quotient of a respective distance between the respective first and second position of the respective further vehicle 4, 42, 43 and/or 44 as the dividend and a length of the first or second measurement period as the divisor. Alternatively or in addition, a Kalman filter may be used to track the respective velocity of the respective further vehicle 4, 42, 43 and/or 44

According to one example, the second control unit 34 may be configured to predict a respective driving path of the respective further vehicle 4, 42, 43 and/or 44 dependent on the position and the velocity of the respective further vehicle 4, 42, 43 and/or 44 and to check whether there is enough space for performing the lane change dependent on the respective predicted path of the respective further vehicle 4, 42, 43 and/or 44. A total area of the zone 500 may be reduced by cutting off parts of the zone 500 using the respective predicted path of the respective further vehicle 4, 42, 43 and/or 44.

By computing the respective predicted path of the respective further vehicle 4, 42, 43 and/or 44 the second control unit 34 may monitor a movement of the respective further vehicle 4, 42, 43 and/or 44 dependent on the first database 300 and the second database 400. It goes without saying that the steps of obtaining the first database 300 and the second database 400 may be repeated continuously in time order to monitor the movement of the respective further vehicle 4, 42, 43 and/or 44. If the area of the zone 500 is smaller than a prescribed area, a performing of the lane change executed by the third control unit 35 may be aborted. Stated differently, the performing of the lane change may be aborted dependent on the movement of the respective further vehicle 4, 42, 43 and/or 44. The area of the zone 500 may be smaller than the prescribed area if the zone 500 extends in the area behind the vehicle 2 by less than the first prescribed length and/or the width of the zone 500 in the area behind the vehicle 2 undercuts the prescribed width. Alternatively or in addition, area of the zone 500 may be smaller than the prescribed area if the zone 500 extends in the area in front of the vehicle 2 by less than the second prescribed length and/or the width of the zone 500 in the area in front of the vehicle 2 undercuts the prescribed width.

In some instances, the second control unit 34 may be configured to generate coordinates of each point of the first point cloud, and coordinates of each point of the second point cloud, on the basis of a vehicle coordinate system 800 as depicted in FIG. 8. The vehicle coordinate system 800 includes an x-axis 801, a y-axis 802 and a z-axis 803. According to the embodiment shown in FIG. 8, the x-axis 801 forms a plane with a rear axle 804 of the vehicle 2 that is perpendicular to the surface of the road 8 on which the vehicle 2 is located. Using the vehicle coordinate system 800 for representing the points of the first point cloud, and the points of the second point cloud, may reduce the computational effort for monitoring the paths of the further vehicle 4, 42, 43 and/or 44 because the x-axis 801 extends to an instant center of rotation 805 of the vehicle 2. The second control unit 34 may generate the coordinates of the respective point of the first or second point cloud on the basis of the vehicle coordinate system 800 by shifting the x-coordinate of the respective point, which is measured on the basis of the x-axis 201, by a constant value and keeping the y-coordinate and the z-coordinate of the respective point unchanged compared to the coordinate system 200 described above.

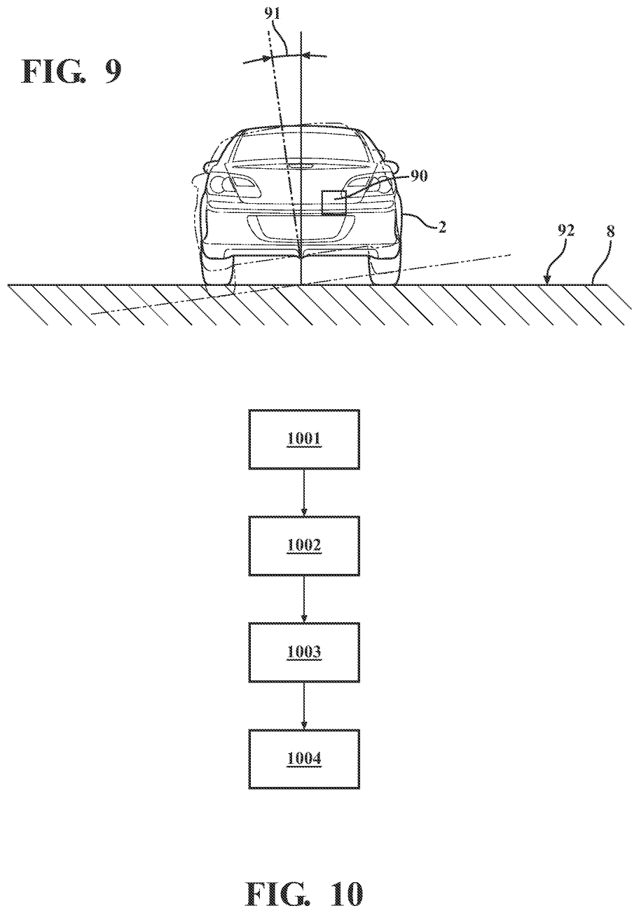

In one example, the driver-assistance system 1 may include an inertial measurement unit 90 (IMU 90). The second control unit 34 may be configured to detect an angle 91 of the vehicle 2 to a surface 92 of the road 8 on which the vehicle 2 is located dependent on further sensor data generated by the IMU 90. The angle 91 may be measured as an angle to the normal of the surface 92 as depicted in FIG. 9. The angle 91 may be produced in traffic situations where the vehicle 2 drives through a curve, which is shown in dashed lines in FIG. 9. The second control unit 34 may be configured to determine the position of the further vehicle 4 dependent on the angle 91 of the vehicle 2 to the surface 92 of the road 8. The second control unit 34 may correct the values of the coordinates of each point of the first, and the second, point cloud taking into account the angle 91 measured by the IMU 90.

FIG. 10 depicts steps of a method for assisting a driver of the vehicle 2 and performing a lane change of the vehicle 2. The method includes the following steps. In a first step 1001, the sensor data is generated by the sensor system 3 for detecting the further vehicle 4, the further vehicles 4, 42, 43, and 44, located in the environment 5 of the vehicle 2. In a second step 1002 the position of the further vehicle 4, the respective position of the further vehicle 4, 42, 43, and 44, may be detected dependent on the sensor data. The position of the further vehicle 4 may be the above mentioned first position of the further vehicle 4. The sensor data may include the first point cloud, in particular the first database 300. The position of the further vehicle 4 may be detected by recognizing the further vehicle 4 dependent on the first point cloud, by using the object recognition module 62. Furthermore, the position of the further vehicle 4 may be calculated by creating a bounding box for representing the further vehicle 4 as mentioned above.

In a third step 1003 it is checked whether there is enough space for performing the lane change of the vehicle 2 dependent on at least the position of the further vehicle 4, dependent on the position of all vehicles 4, 42, 43, and 44 in the environment 5. In one example, the second control unit 34 may check whether there is enough space for performing the lane change by checking whether the area of the zone 500 is greater than the prescribed area. This may be checked according to one of the above mentioned variants.

In a fourth step 1004, the signal for initiating the performing of the lane change may be generated wherein when there is enough space for performing the lane change. The signal for initiating the performing of the lane change may be generated by enabling the above mentioned driver-vehicle-interface, the button 70, or by sending the trigger signal to the third control unit 35. In the last case, the vehicle 2 may perform the lane change automatically, wherein the third control unit 35 may control the steering system, the drive unit, and the brake system, dependent on the sensor data. A position of the vehicle 2 after performing the lane change is shown in dashed lines in FIG. 4.

In one example, the method may further involve determining the velocity of the further vehicle 4 dependent on the sensor data and predicting the driving path of the further vehicle 4 dependent on the position and the velocity of the further vehicle 4. In one example, the method may further include checking whether there is enough space for performing the lane change dependent on the predicted path of the further vehicle 4.

The method may further include monitoring the movement of the further vehicle 4 dependent on the sensor data, by the second control unit 34, and aborting the performing of the lane change dependent on the movement of the further vehicle 4. For example, the performing of the lane change may be aborted wherein when the further vehicle 4 cuts into the zone 500 shown in FIG. 4.

The first control unit 20, the second control unit 34 and the third control unit 35 may include one or more processors, such as the processor 60 shown in FIG. 6, and other components, for example one or more memory modules, such as the volatile memory 61 shown in FIG. 6. Each of the one or more processors may be a controller, an integrated circuit, a microchip, or any other computing device. The one or more memory modules may be non-transitory computer readable medium and may be configured a RAM, ROM, flash memories, hard drives, and, or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, etc., that may be compiled or assembled into computer-executable instructions and storage on the one or more memory modules. Alternatively, the computer-executable instructions may be written in our hardware description language, such as logic implemented via either a field programmable gate array (FPGA) configuration or an application specific integrated circuit (ASIC), all their equivalents. Accordingly, the methods described herein may be implemented in any conventional computer programming language, as preprogrammed hardware elements, or as a combination of hardware and software components.

A part of the computer-executable instructions may be stored in aggregate form in order to realize a function. For example, the object recognition module 62 may be an aggregation of a first set of computer-executable instructions for recognizing objects on the road 8, the further vehicle 4, 42, 43 and/or 44, dependent on the sensor data. The evaluation module 64 may be considered as an aggregation of a second set of computer-executable instructions for evaluating whether there is enough space for performing the lane change. The main program 63 may be an aggregation of a third set of computer-executable instructions for operating the second control unit 34 such that the second control unit 34 may assess whether there is enough space for performing the lane change on the basis of the sensor data and may generate the signal for initiating the lane change. On a processor of the first control unit 20 a further main program may be executed, not shown in the figures, for controlling the drive unit 30, the laser 21 and for processing the electric signals of the detector 29.

The volatile memory 61 together with the main program 63, the object recognition module 62 and the evaluation module 64 being stored on the memory 61 may be considered as a computer program product. The computer program product may include a computer-readable storage medium, in this case the memory 61, having computer-readable program code embodied therewith, in this case the modules 62, 64 and the main program 63. The computer-readable program code may be configured, programed, to implement the steps of the method according to one of the variants described above.

The one or more processors, the processor 60 and the processor of the first control unit 20, may be coupled to first communication paths that provide signal interconnectivity between the detector 29, the drive unit 30, the laser 21 and the processor of the first control unit 20. Communication between the drive unit 30 and the first control unit 20 and a communication between the laser 21 and the first control unit 20, and a communication between the detector 29 and the first control unit 20 may involve sending electrical signals, such as the above mentioned a respective electrical signals, via the first communication paths. A further communication between the third control unit 35 and the components of the vehicle 2 may be performed using a vehicle bus, such as, for example a CAN bus, a LIN bus, a VAN bus, and the like.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A driver-assistance system for assisting a driver of a vehicle in performing a lane change of the vehicle, the driver-assistance system comprising:
a sensor system for detecting a further vehicle located in an environment of the vehicle, the sensor system includes a continuously spinning Lidar sensor mounted on a roof of the vehicle,
wherein the driver-assistance system is configured to:
detect a position of the further vehicle dependent on sensor data generated by the sensor system,
check whether there is enough space for performing the lane change of the vehicle dependent on at least the position of the further vehicle, and
generate a signal for initiating the lane change wherein when there is enough space for performing the lane change.

2. The driver-assistance system according to claim 1, wherein the signal for initiating the lane change is in the form of an enabled driver-vehicle-interface for initiating the lane change.

3. The driver-assistance system according to claim 1, wherein the driver-assistance system is configured to initiate the lane change autonomously in response to a generation of the signal for initiating the lane change.

4. The driver-assistance system according to claim 1, wherein the driver-assistance system further comprises:
an inertial measurement unit (IMU),
wherein the driver-assistance system is configured to:
detect an angle of the vehicle to a surface of a road on which the vehicle is located dependent on further sensor data generated by the IMU, and
determine the position of the further vehicle dependent on the angle of the vehicle to the surface of the road.

5. The driver-assistance system according to claim 1, wherein the driver-assistance system is further configured to:
determine a velocity of the further vehicle dependent on the sensor data;
predict a driving path of the further vehicle dependent on the position and the velocity of the further vehicle; and
check whether there is enough space for performing the lane change dependent on the predicted driving path of the further vehicle.

6. The driver-assistance system according to claim 1, wherein the driver-assistance system is further configured to:
monitor a movement of the further vehicle dependent on the sensor data; and
abort a performing of the lane change dependent on the movement of the further vehicle.

7. The driver-assistance system according to claim 1, wherein:
the sensor data is in the form of a point cloud; and
the driver-assistance system is configured to remove points of the point cloud that represent points located on a surface of a road on which the vehicle is located from the point cloud.

8. The driver-assistance system according to claim 7, wherein the driver-assistance system is configured to:
generate coordinates of each point of the point cloud on the basis of a coordinate system of the vehicle,
wherein one axis of the coordinate system of the vehicle forms a plane with a rear axle of the vehicle that is perpendicular to a surface of a road on which the vehicle is located.

9. A method for assisting a driver of a vehicle in performing a lane change of the vehicle, the method comprising the following steps:
generating sensor data by a sensor system for detecting a further vehicle located in an environment of the vehicle, wherein the sensor system includes a continuously spinning Lidar sensor mounted on a roof of the vehicle;
detecting a position of the further vehicle dependent on the sensor data;
checking whether there is enough space for performing the lane change of the vehicle dependent on at least the position of the further vehicle; and
generating a signal for initiating a performing of the lane change wherein when there is enough space for performing the lane change.

10. A computer program product comprising a computer-readable storage medium having computer-readable program code embodied therewith, wherein the computer-readable program code is configured to:
generate sensor data by a sensor system for detecting a further vehicle located in an environment of the vehicle, wherein the sensor system includes a continuously spinning Lidar sensor mounted on a roof of the vehicle;
detect a position of the further vehicle dependent on the sensor data;
check whether there is enough space for performing the lane change of the vehicle dependent on at least the position of the further vehicle; and
generate a signal for initiating a performing of the lane change wherein when there is enough space for performing the lane change.
